(19) United States
(12) Patent Application Publication
(10) Pub. No.: US 2009/0139426 A1
(43) Pub. Date: Jun. 4, 2009

(54) Method of Producing a Wall Part for a Car or a Covering Hood for a Chair of a Cableway System

(75) Inventor: Ekkehard Assmann, Dornbirn (AT)

Correspondence Address: LERNER GREENBERG STEMER LLP, P O BOX 2480, HOLLYWOOD, FL, 33022-2480, US

(73) Assignee: INNOVA PATENT GMBH, Wolfurt (AT)

(21) Appl. No.: 12/210,376

(22) Filed: Sep. 15, 2008

(30) Foreign Application Priority Data
Dec. 3, 2007 (AT) A 1963/2007

(51) Int. Cl. B29C 51/46; B61B 12/00; A47C 7/00

(52) U.S. Cl. 105/149.2; 264/40.1; 297/184.11

(57) ABSTRACT

A method of producing a wall part for a gondola of a cableway system or a covering hood for a lift chair starts out from a panel made of plastic material, in particular of polycarbonate. The panel is introduced into a heatable mold, and pressed therein, in order to form the wall part or the covering hood. The plastic material of the panel contains at least one dye. Different gradations of color of the wall part or of the covering hood indicate different wall thicknesses and insufficient wall thicknesses of this wall part or covering hood.

### CROSS-REFERENCE TO RELATED APPLICATION

This application claims the priority, under 35 U.S.C. §119, of Austrian patent application A 1963/2007, filed Dec. 3, 2007; the prior application is herewith incorporated by reference in its entirety.

### BACKGROUND OF THE INVENTION

1. Field of the Invention

The present invention relates to a method of producing a wall part for a car of a cableway system or a covering hood for use on a chair of a cableway system. A panel made of a plastic material, in particular polycarbonate, is thereby introduced into a heatable mold, and pressed therein, in order to produce the wall part or the covering hood.

Conventional cablecars are formed predominantly with wall parts made of a transparent plastic material. It is likewise the case that the covering hoods for chairs of cableway systems are produced from a transparent plastic material. The advantage of forming cablecars with a very large number of transparent wall parts, or of forming chair-covering hoods which are transparent, resides in the particular level of convenience for the users of the cars or of the chairs, who are thus afforded a largely unrestricted view of the landscape.

The transparent wall parts necessary for cars, or chair-covering hoods, which consist of a plastic material e.g. of polycarbonate, are produced by panels of the plastic material being pressed in heated molds, this achieving the desired three-dimensional configurations.

Wall parts for cablecars and covering hoods for chairs therefore have to have largely constant wall thicknesses of approximately 3 mm to 5 mm in order thus to ensure the necessary strength. Production of these wall parts and of the covering hoods, however, gives rise to the problem where, on account of the resistances during the deformation of the plastic material which are brought about by the different three-dimensional configurations, it is possible for regions which have insufficient wall thicknesses to form. This applies, in particular, to corner regions. If these shortcomings are not detected, these products are processed further, i.e. they are used in cars and for chairs in which case the insufficient strength results, within short periods of operation, in damage, in particular fracturing, which makes it necessary for the relevant wall parts or covering hoods to be replaced by new wall parts or new covering hoods.

### SUMMARY OF THE INVENTION

It is accordingly an object of the invention to provide a method for producing a wall part for a gondola or a covering hood for a chair of a cableway system which overcomes the above-mentioned disadvantages of the heretofore-known devices and methods of this general type and which allows these production-related shortcomings of a wall part or of a covering hood to be immediately detected and, as a result, to allow these wall parts or these covering hoods to be separated out straightaway.

With the foregoing and other objects in view there is provided, in accordance with the invention, a method of producing a wall part for a car of a cableway system or a covering hood for a chair of a cableway system. The method comprises the following steps:

providing a panel made of a plastic material, preferably polycarbonate, and containing at least one dye;

introducing the panel of plastic material into a heatable mold and pressing the panel in the mold to produce therefrom the wall part or the covering hood;

inspecting the wall part or covering hood with regard to color gradations, wherein different color gradations of the wall part or covering hood indicate different wall thicknesses and possibly insufficient wall thicknesses.

In accordance with an added feature of the invention, if color gradations of the wall part or covering hood indicate an insufficient wall thickness, the wall part or covering hood can be separated out and classifies as a reject.

In accordance with an additional feature of the invention, the panel made of plastic material has a thickness of 3 mm to 5 mm.

With the above and other objects in view, there is also provided a chair for a cableway system, comprising a carrying frame and a seat surface supported on said covering frame, and a covering hood pivotally mounted on said carrying frame between an open position and a closed position and produced by the above-outlined method. Similarly, there is provided a gondola for a cableway system, comprising wall parts produced by the above-outline method.

In other words, the objects of the invention are achieved in that the plastic material of the panel contains at least one dye, different gradations of color of the wall part or of the covering hood indicating different wall thicknesses and insufficient wall thicknesses of this wall part or covering hood.

Other features which are considered as characteristic for the invention are set forth in the appended claims.

Although the invention is illustrated and described herein as embodied in method of producing a wall part for a car or a covering hood for a chair of a cableway system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of a lift chair of a cableway-system with a covering hood, which is illustrated in an open position; and

FIG. 2 is a similar perspective view of the chair according to FIG. 1, this time with the covering hood in the closed position.

### DETAILED DESCRIPTION OF THE INVENTION

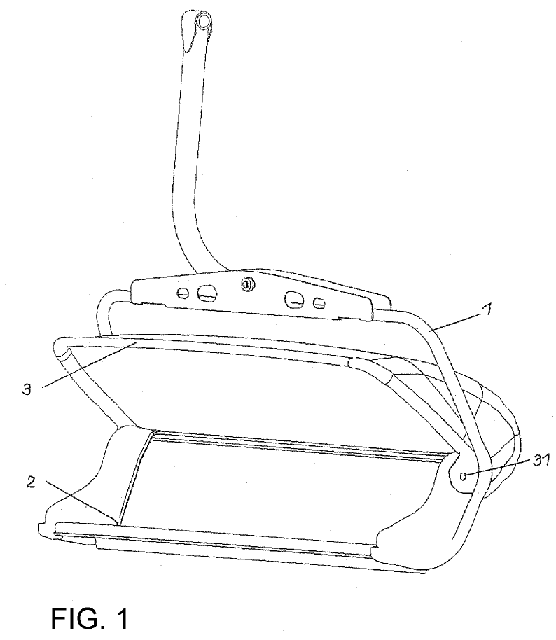

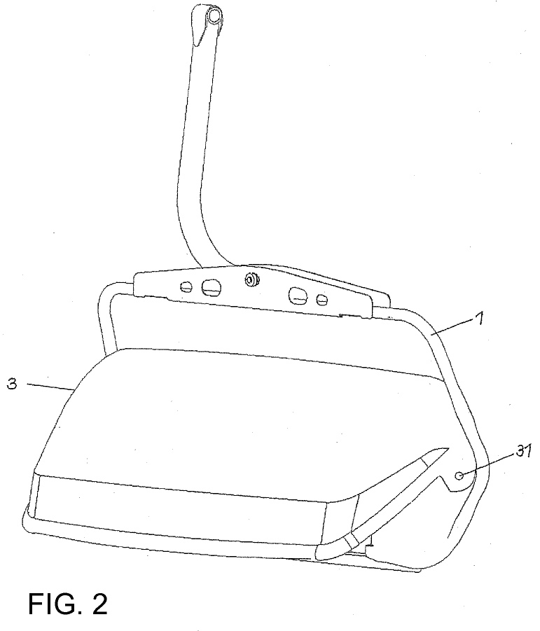

Referring now to the figures of the drawing in detail, the cableway-system chair which is illustrated as an exemplary embodiment of the invention comprises a carrying frame 1 which has a seat surface 2 for a number of passengers. In order to provide the passengers protection, for instance from inclement weather, a covering hood 3, also referred to as a bubble, is mounted on the carrying frame 1. The hood 3 is pivotally mounted about an axis 31. In the open position of the covering hood 3—the position illustrated in FIG. 1—passengers can be seated and they can disembark from the chair. If the passengers require protection against wind, snowfall or other climatic effects as they are traveling on a cableway system, the covering hood 3 is pivoted into the closed position—the position illustrated in FIG. 2.

The covering hood 3 is produced fully, or for the most part, from a plastic material, in particular from polycarbonate, to which at least one dye is added. The addition of a dye thus makes it possible to detect, following production of the covering hood, whether the latter has the wall thickness of approximately 3 mm to 5 mm which is necessary for the desired strength, since regions with a small wall thickness have a lighter tinting than regions with a greater wall thickness.

If it is established that a covering hood has one or more regions with an insufficient wall thickness, and thus obviously does not ensure the necessary strength, this covering hood is separated out. Since this, to the greatest extent possible, rules out production-related damage, in particular fracturing, changeover operations which would otherwise be necessary are avoided, and substantial savings in cost are achieved as a result.

Producing covering hoods from a plastic material which contains a dye, furthermore, results in the covering hood being heated up more quickly and being de-iced more quickly. In addition, such a covering hood provides a certain amount of shade and antidazzle protection for the users of the chair.

It will be readily understood that such covering hoods can be used both for chairs which are rigidly fastened on the carrying and conveying cable of a cableway system and for chairs which can be coupled to the carrying and conveying cable.

The same advantages as outlined also apply to cableway-system cars and gondolas that are formed with transparent wall parts.

1. A method of producing a wall part for a car of a cableway system or a covering hood for a chair of a cableway system, the method which comprises:
providing a panel made of a plastic material and containing at least one dye;
introducing the panel of plastic material into a heatable mold and pressing the panel in the mold to produce therefrom the wall part or the covering hood;
inspecting the wall part or covering hood with regard to color gradations, wherein different color gradations of the wall part or covering hood indicate different wall thicknesses and possibly insufficient wall thicknesses.

2. The method according to claim 1, which comprises, if color gradations of the wall part or covering hood indicate an insufficient wall thickness, separating the wall part or covering hood out and classifying it as a reject.

3. The method according to claim 1, wherein the plastic material is polycarbonate.

4. The method according to claim 1, wherein the panel made of plastic material has a thickness of 3 mm to 5 mm.

5. A chair for a cableway system, comprising:
a carrying frame and a seat surface supported on said covering frame;
a covering hood pivotally mounted on said carrying frame between an open position and a closed position and produced by the method according to claim 1.

6. A gondola for a cableway system, comprising wall parts produced by the method according to claim 1.
